(19) United States
(12) Patent Application Publication
(10) Pub. No.: US 2019/0122161 A1
(43) Pub. Date: Apr. 25, 2019

(54) Real-Time Skills-Based and Competency Assessment System and Method

(71) Applicant: Frank C. Cicio, JR., New York, NY (US)

(72) Inventor: Frank C. Cicio, JR., New York, NY (US)

(73) Assignee: iQ4 LLC, FRANKLIN LAKES, NJ (US)

(21) Appl. No.: 16/171,226

(22) Filed: Oct. 25, 2018

Related U.S. Application Data
(60) Provisional application No. 62/576,913, filed on Oct. 25, 2017.
(60) Provisional application No. 62/576,983, filed on Oct. 25, 2017.
(60) Provisional application No. 62/577,263, filed on Oct. 26, 2017.
(60) Provisional application No. 62/577,287, filed on Oct. 26, 2017.
(60) Provisional application No. 62/577,376, filed on Oct. 26, 2017.
(60) Provisional application No. 62/577,406, filed on Oct. 26, 2017.

(51) Int. Cl. G06Q 10/06; G06F 17/30; G06F 9/451

(52) U.S. Cl. CPC G06Q 10/063112; G06F 9/451; G06F 17/30312

(57) ABSTRACT

A skills portfolio passport is generated based on skills and competency assessments in combination with “real-time” applied knowledge data. The skills portfolio passport is stored in an immutable data structure, such as a blockchain. The passport is utilized to showcase the talent of a certain individual and further utilized to, using digital technology, match the individual with a certain role (i.e. employment). A natural language processing engine is utilized to analyze common streams of applied learning data.

### PRIORITY

This application claims the benefit of U.S. Provisional Application No. 62/576,913, filed Oct. 25, 2017, U.S. Provisional Application No. 62/576,983, filed Oct. 25, 2017, U.S. Provisional Application No. 62/577,263, filed Oct. 26, 2017, U.S. Provisional Application No. 62/577,287, filed Oct. 26, 2017, U.S. Provisional Application No. 62/577,376, filed Oct. 26, 2017, and U.S. Provisional Application No. 62/577,406, filed Oct. 26, 2017, which are all hereby incorporated by reference.

### FIELD OF THE INVENTION

The present invention relates to systems and methods for skills and competencies assessment, and, more particularly, skills portfolio assessment and management by immutable data structures.

### BACKGROUND

Today, businesses capable of providing good jobs and career-type employment are frustrated from the lack of finding qualified applications. Vice versa, job applicants are frustrated with their lack of success at finding new employment or reasonably ascertaining and gaining a keen understanding the skills employers are looking for in a candidate. This rapidly growing skills gap requires new and interactive solutions that promote skills identification, development, portfolio creation and commercial interaction in a secure and auditable manner.

### BRIEF DESCRIPTION OF THE DRAWINGS

This disclosure is illustrated by way of example and not by way of limitation in the accompanying figure(s). The figure(s) may, alone or in combination, illustrate one or more embodiments of the disclosure. Elements illustrated in the figure(s) are not necessarily drawn to scale. Reference labels may be repeated among the figures to indicate corresponding or analogous elements.

The detailed description makes reference to the accompanying figures in which:

FIG. 1 illustrates a skills and competency assessments computing platform in accordance with an embodiment of the disclosed invention;

FIG. 2 illustrates a four-dimensional framework in accordance with another embodiment of the disclosed invention;

FIG. 3 illustrates an optimization diagram in accordance with another embodiment of the disclosed invention;

FIG. 4 illustrates a natural language processing diagram in accordance with another embodiment of the disclosed invention;

FIG. 5 illustrates an exemplary workflow diagram in accordance with another embodiment of the disclosed invention;

FIG. 6 illustrates an exemplary distributed ledger in accordance with another embodiment of the disclosed invention;

FIG. 7 is an exemplary block diagram of a computing system in accordance with the disclosed invention; and

FIGS. 8A-8F provide an exemplary data visualization in accordance with one or more embodiments of the disclosed invention.

### DETAILED DESCRIPTION

The figures and descriptions provided herein may have been simplified to illustrate aspects that are relevant for a clear understanding of the herein described apparatuses, systems, and methods, while eliminating, for the purpose of clarity, other aspects that may be found in typical similar devices, systems, and methods. Those of ordinary skill may thus recognize that other elements and/or operations may be desirable and/or necessary to implement the devices, systems, and methods described herein. But because such elements and operations are known in the art, and because they do not facilitate a better understanding of the present disclosure, for the sake of brevity a discussion of such elements and operations may not be provided herein. However, the present disclosure is deemed to nevertheless include all such elements, variations, and modifications to the described aspects that would be known to those of ordinary skill in the art.

Embodiments are provided throughout so that this disclosure is sufficiently thorough and fully conveys the scope of the disclosed embodiments to those who are skilled in the art. Numerous specific details are set forth, such as examples of specific components, devices, and methods, to provide a thorough understanding of embodiments of the present disclosure. Nevertheless, it will be apparent to those skilled in the art that certain specific disclosed details need not be employed, and that exemplary embodiments may be embodied in different forms. As such, the exemplary embodiments should not be construed to limit the scope of the disclosure. As referenced above, in some exemplary embodiments, well-known processes, well-known device structures, and well-known technologies may not be described in detail.

The terminology used herein is for the purpose of describing particular exemplary embodiments only and is not intended to be limiting. For example, as used herein, the singular forms “a,” “an,” and “the” may be intended to include the plural forms as well, unless the context clearly indicates otherwise. The terms “comprises,” “comprising,” “including,” and “having” are inclusive and therefore specify the presence of stated features, integers, steps, operations, elements, and/or components, but do not preclude the presence or addition of one or more other features, integers, steps, operations, elements, components, and/or groups thereof. The steps, processes, and operations described herein are not to be construed as necessarily requiring their respective performance in the particular order discussed or illustrated, unless specifically identified as a preferred or required order of performance. It is also to be understood that additional or alternative steps may be employed, in place of or in conjunction with the disclosed aspects.

When an element or layer is referred to as being “on,” “engaged to,” “connected to,” or “coupled to” another element or layer, it may be directly on, engaged, connected or coupled to the other element or layer, or intervening elements or layers may be present, unless clearly indicated otherwise. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). Further, as used herein the term “and/or” includes any and all combinations of one or more of the associated listed items.

Yet further, although the terms first, second, third, etc. may be used herein to describe various elements, components, regions, layers and/or sections, these elements, components, regions, layers and/or sections should not be limited by these terms. These terms may be only used to distinguish one element, component, region, layer or section from another element, component, region, layer or section. Terms such as “first,” “second,” and other numerical terms when used herein do not imply a sequence or order unless clearly indicated by the context. Thus, a first element, component, region, layer or section discussed below could be termed a second element, component, region, layer, or section without departing from the teachings of the exemplary embodiments.

### Assessments & Blockchain & Skills Passport

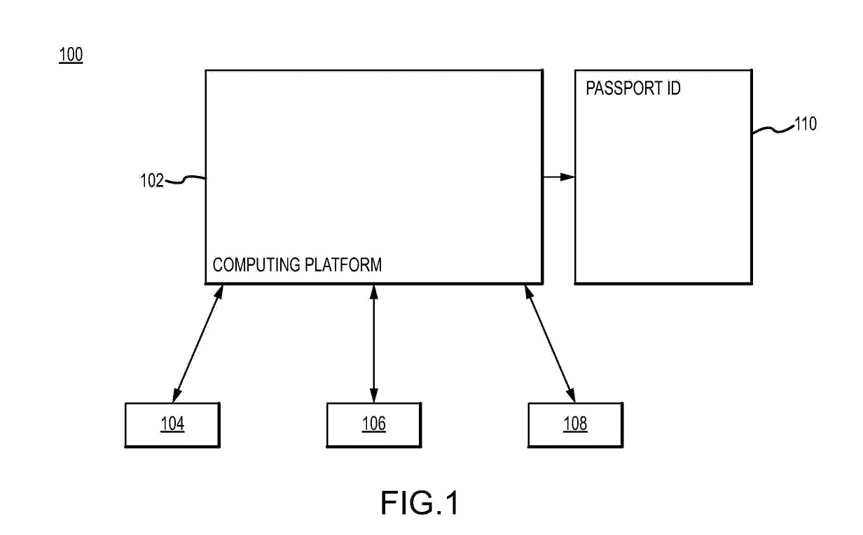

Assessments (skills and applied knowledge): In accordance with FIG. 1, the computer platform 102 may include skills and competency assessments as well as include a “real-time” applied knowledge data and computer engine that may be used for both formative and summative assessments, thus providing guidance and feedback to mentors, instructors and students (104, 106, 108). The platform may segment instructional components/assignments/challenges and capture the content and context of a student's ability to assess academic applied knowledge. The platform may compute a machine learning/natural language processing analytics engine to find themes that compare to best practices and align to the skills (essential and technical skills) and competencies assessments. In addition, subject matter experts may comment on an individual's applied knowledge in content/context form as-well-as apply a real-time proficiency assessments based on a standard taxonomy framework and maturity assessment model.

Skills assessments may include, but are not limited to: self, peer, instructor, tested, applied, manager, lab etc. In the event that more than an individual assessment is performed the platform aggregates and computes the average scoring and recommends courses using open integration standards and mapping of competencies and KSAs to existing eco-system applications (eg HR, SIS, LMS). The machine may calculate the aggregate of the extended role profile data, mapping to courses within existing learning management systems and external offerings, and tracks enrollment and completion at the competency and KSA level the machine that aggregates, validates and certifies this information in the Skills Passport 110. Calculations of results are then applied to measure skills performance/progression/predictive/potential and sense of purpose state of showcasing individual's personas over time. The machine's ability to aggregate date, apply NLP and predictive modeling analytics validate over time is critical to scale solutions with enterprise, academic institutions, state, governments and global large data. The machine model and math techniques may be used to apply against internal structured data (private networks) and unstructured and distributed architectures and networks (eg blockchain) to source, validate and audit virtual ledgers containing skills and competency assessments that align to this applications framework.

Skills Passport (immutable) Blockchain Skill Score/Bar Code/Co-Curricula Transcript: Personal identity (Global ID), privacy (data), trust (source), skills-based taxonomy frameworks (architecture), Governance models and policy create the compute engine foundation to develop and capture work products, academic records and transcript, certifications, background data (credit and criminal), experiential data and extra-curricular interests. The platform's architecture supports both a private (Amazon AWS®) and public (Blockchain) distributed, or decentralized, network, using a dynamic attribute-based repository to capture and build Skills Passport life-long learning “personas” over time. Use of Blockchain and Open Object distributed ledgers and data qualification methodologies and architecture expands the ability to validate data, source, acquire data assets (skills, credentials, academic and workplace experience, in a secured ledger to empower individuals regarding career mobility, branding and trusted data using advanced technology (for example, a bar code for People). This will result in a leveled playing field viral adoption, aligning global supply/demand talent capacity and pipeline, from early to advanced education, scaffolding mapping to personality traits, real-world skills defined by industry, to pathways leveraging applied learning real-world projects to workforce ready talent. The data and format is standards based and accepted by the policy setting academic boards in the United States. Reference PESC award co-curricular transcript.

Skills Passport (overview): the aggregation of compute engine analytics and data structure to showcase talent using the most advanced technology. The Skills Passport represents an individual's skills-based DNA. Visualized in an interactive protected and secured authentication empowered platform, individuals showcase their fingerprint/DNA of skills and aligning/preparedness for perfect matching of job roles and pathways that will increase retention, employment, alignment with passion, decreased anxiety and depression of current state. Data structure extension include portfolio work product (files, video, links), academic history (degrees, courses, schools, transcripts), financial and legal background history, work experience, professional certifications and personal interests. Data is verified and verified from its “source”. Source data may be accessed directly in private networks using APIs and/or distributed ledgers (Blockchain) to capture and track data. This information is credentialed (digital badge) and is controlled by the individual (privacy and empowerment).

Nirvana is reality: personality traits aligned with pathways and roadmaps . . . optimize the pursuit of achievement and victory, maximize economic development through resource alignment. The Skills Passport combines the 5 P's: Performance, Progression, Predictive, Potential and Purpose . . . a transformational new way to showcase an individual's “Persona” using digital technology.

### Role Profiles & Pathways

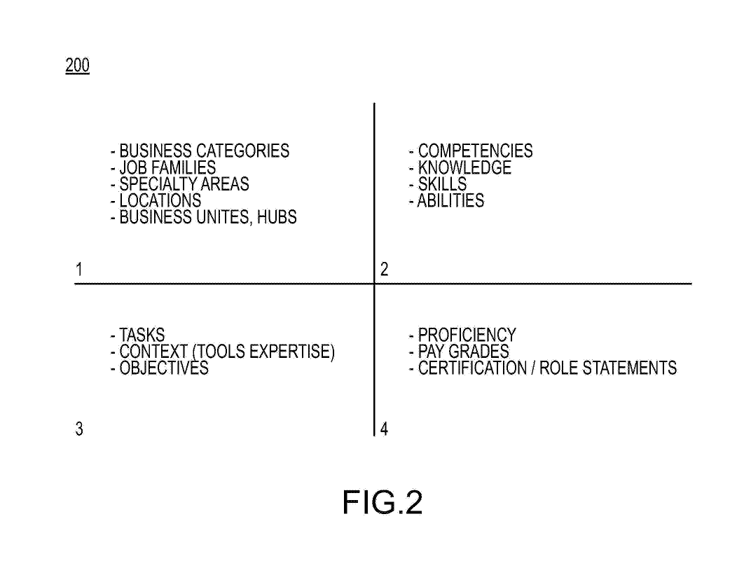

Role Profiles may include a four-dimensional framework (see FIG. 2, diagram 200), standards based taxonomy and governance model to defining target state and current state of workforce resource capacity, risk, mobility and load balancing. this cannot be accomplished without automation and critical to optimize workforce allocation, cost optimization and pipeline management from pro-secondary education to master degree and succession planning including, but not limited to: Dimension 1—business categories, job families, specialty areas, locations, business units, HUBs. Dimension 2—competencies, knowledge, skills and abilities. Dimension 3—tasks, context (tools expertise), and objectives. Dimension 4—proficiency (competency and KSA levels), pay grades, certifications and role statements (skills required, asset, nice to have). Private distributed architectures such as blockchain will be used to extend data gathering (eg defining roles, assessments of skills, source validation) in defining roles across the enterprise and its ecosystem of partners.

Pathways: leveraging target state, current state and skills capacity data structures and profiles, the computing platform may calculate “predictive; career pathways models. These models use computation algorithms and data attributes to visualize desired careers based on current skills passport data (as defined in role profiles, assessments and taxonomy). Pathways as defined by role profiles may be visualized by the computed using multi-dimensional filters (defined in role profiles). Potential roles selected will define a pathway to career paths, recommended courses and certifications and opportunities within the enterprise and its ecosystem and academic and career markets at large. The Pathways compute engine is used to compute forward looking role profiles for enterprise professionals. Even further, Pathways may align role profiles with individual personality traits, key to aligning with student interest in early education (middle school-high school-post secondary education). The taxonomy and role profile data structure is used to map student interest with long term career goals (e.g., a large bank can define its core businesses, then assign roles and skills and map these back to student personality traits). Students can then participate in projects to verify and validate their interests. All information can be measured and verified as a system of record and part of the Skills Passport. Example of modeling;

Pathways Algorithms:

Recommender System

1. Convert each role profile into a sparse vector of skills where each skill is weighted by the required proficiency level,

example:

someRoleProfile=[0,0,0,1,0,2,0,0,0 . . . 4]

where 0=skill not in profile, 1,2,3,4=skill proficiency requirement

2. The same vectorization technique is applied to the employee, which may include additional skills outside of their assigned Role Profile.

To display best match:

3. Calculate the Euclidean distance between the individual and all role profiles in the system. The Role Profile with the shortest distance is the best match for the individual.

With options to filter by business unit and/or job family

To generate a path involving intermediate role profiles:

4. Generate a network graph using Euclidean distances between all role profiles to determine edges and edge weights between nodes, where a node is a Role Profile.

### SAAS Skills Language

SAAS Skills Language (Skilling as A Service): core to the compute engine is the Four Tier Taxonomy data structure. As referenced in the role profile the data attributes defined leverages a new taxonomy/ontology framework that defines a standard new “skills language”. The taxonomy framework may use a 4-Tier Taxonomy and Dimensional approach that provides industry and government the ability to define the optimal competency and KSA resources required to support the business and public sector infrastructure. This standards approach 4-Tier Framework creates a common standards “language” for academic institutions. This data structure and compute engine model solves the epic challenge existing today between education and industry/government, providing a common “skills language” where employers can define job role profiles at a granularity required to illustrate the core skills required match candidates to jobs. On the flip side the 4-Tiered approach directly maps Role Profiles to Degrees, Concentrations, Courses and Learning Outcomes (see Table 1).

TABLE 1

| Industry | Education |
|---|---|
| Role Profile - Risk Analyst | Major - Business |
| Dimension 1 Technology/Cybersecurity/ | Minor/Concentration - Forensics |
| Singapore | |
| Dimension 2 Third Party/Authentication | Course - Analytics/Big Data |
| Dimension 3 Mobile Computing/OAuth | Learning Outcome - Single |
| | Sign-On Authentication |
| Dimension 4 High | Degree: maps to proficiency |
| School/Graduate/Certifications | levels and pay grades |

Creating a common language between industry and education as a standards protocol establishes a common ground that bridges the skills gap requirements of employers and educational programs, this will accelerate the workforce readiness and scale of graduating students and professionals. Once defined as a standards based data structure, the 4-Tiered Framework may be used to measure both applied learning and academic skills scoring (using the competency based education model) for an individual's performance, progression over time, predictive pathways, potential to succeed and capacity to achieve a “sense of purpose”, an ultimate next generation vision and mission for our next generation workforce.

The platform may incorporate blockchain distributed architecture to source trusted extensions of the 4-Tiered Taxonomy (4TT) framework, captured in private and open audit ledgers. Over time these 4TT Ledgers will aggregate and optimize data over global scale, to include all disciplines in public, private, and academic sectors. For the greater good, this approach is the first of its kind to integrate a standards based approach, to establish a “common language”, across an individual's life learning career, in a transparent and “real time” knowledge sharing process.

### Load Balancing

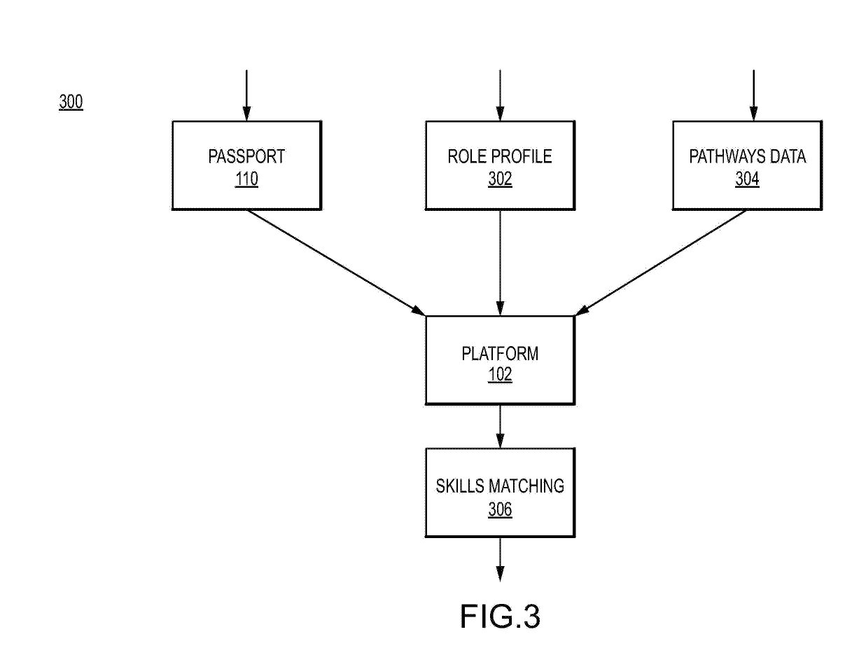

Load Balancing: Referring to diagram 300 of FIG. 3, leveraging the Skills Passport 110, Role Profile 302, and Pathways data 304—the platform 102 using data model analytics, optimizes and recommendation skills matching 306 for human resource capacity using an active multi-dimension modeling approach BY; geographic location, line of business, specialty category, priority etc., aligned with project requirements across all role profile filters on a global scale. The platform may model predictive analytics to model forward looking business project resource requirements as well as pipeline new talent from post-secondary, high school and middle school resources, aligned with an individual's personal traits through the business roles and skills required (front to back career mapping).

### Natural Language Processor

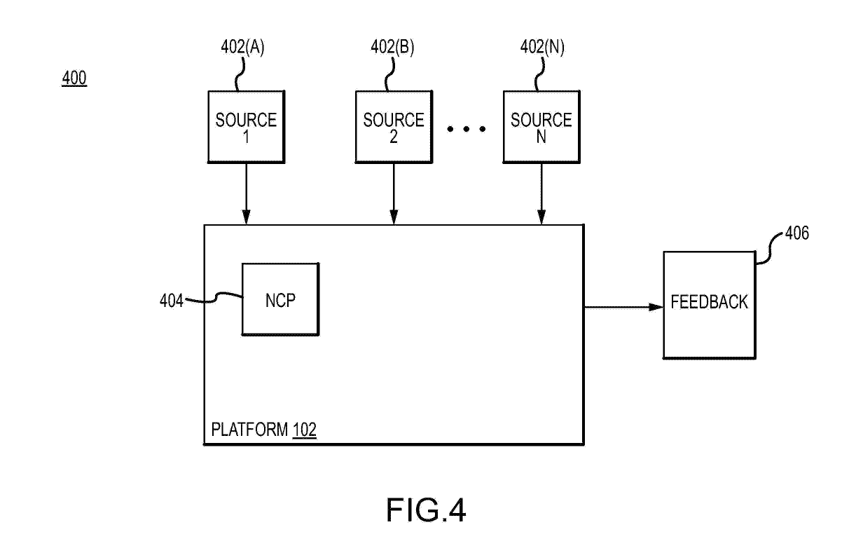

Natural Language Processor (NLP): Referring now to diagram 400 of FIG. 4, the platform 102 may be optimized to analyze common streams (Source 402(A), Source 402(B), . . . Source 402(N)) by NLP 404 of applied learning data. Meaning mentor and student comments in project discussions and assignments, as well as Skills Passport assessments, utilize data mining algorithms based on comments, video, papers to understand patterns in behavior re essential skills and technical skills. The NLP engine 404 aggregates common themes from multiple sources and provides suggested feedback 406 for all participants in terms of fine tuning and improving responses. (eg written memo should be 1.5 pages' vs 15 pages with the topic stated up front, in the end and content explained throughout the document.). Most important are essential skills that are fundamental to any career. All work product (discussions, assignments, videos, files, presentations etc) are analyzed, intelligence is built over time to obtain “digital instructor” approach to identify and accelerate inefficiencies in an individual's soft skills proficiencies. The compute engine leverages the ability to combine SME assessments and student behavior to predict performance and progression. The platform, models and content unique combination, results in a highly scalable assessment of student and professional's proficiency of applying academic and trained background to real-world projects.

### Applied Learning

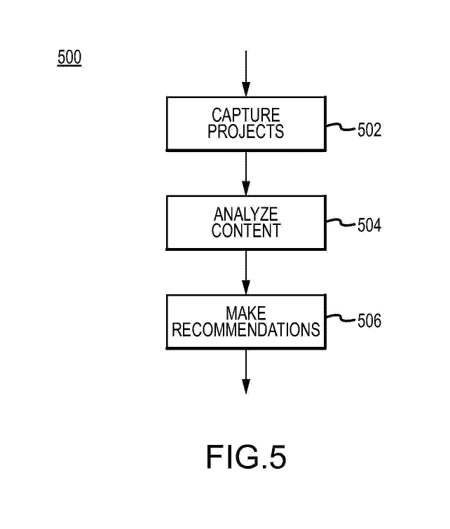

Applied Learning/Project-Based/On-Boarding: Referring to workflow diagram 500 of FIG. 5, a third and critical component to enabling applied learning assessments and validation is the ability to capture real-world projects (step 502), defined by industry, representing workforce jobs, and extending these projects into the classroom, mentored by subject matter experts. We refer to this as “virtual mentorship” or otherwise “on-the-job-training” while students are in the class, albeit virtually. Projects represent real-world scenarios that new hired students or professionals can participate in advance of actual employment, this reduces the risk of hiring the wrong talent or accepting the wrong offer. Projects data structure includes curriculum that is aligned with assignments. Assignments are structured to invoke open text response, document based response and video response. NLP engine 404 may analyze content (step 504) to find common themes from subject matter experts over time, and then make recommendations (step 506) on ways to refine assignment work product, this includes essential skills (communications, critical thinking, problem solving, leadership and professionalism) as well as technical skills depending on the discipline. Skills are assessed, measured for performance and progressions and outcomes measure by student and professional placement that out performs by 2:1 any market data available today.

In various embodiments, a blockchain, or distributed ledger, provides a decentralized approach to tracking information. By eliminating the need for a central authority, information and transactions therewith may be circulated and verified over a network. A blockchain may provide a secure solution for tracking, for example, the ownership and transfer of assets. In a simplified example, a blockchain may provide proof of who owns what at any given point in time and be replicated on hundreds or thousands of computing nodes.

Blockchain structure offers solutions to the dilemma of balancing data, identity, and transaction-based privacy and security. By way of example, security and privacy breaches have occurred, and may continue to happen, within large, often centrally organized entities, such as, for example, big box store retailers, social networks, closed networks, governments and militaries. For consumer facing entities, the privacy and security of customer information, payment information, and transaction histories may be paramount to the success of the business. For closed networks, governments and military networks, the security of data is often directly related to the safety and security of a group of people.

As described herein, blockchain and the related decentralized applications based on blockchain may provide solutions to data security, for example, when using cryptographically-secured encryption as a part of the blockchain used in the particular applications, especially as related to the data parts. Although current systems and networks encrypt data, the decentralizing of various aspects of an information architecture may allow for unintended breaches in currently employed encryption chains and layers as, for example, individual users manipulate and interact with their own data. Using blockchain to hold data, authentication information, and encryption aspects, user data and central repositories may be less vulnerable to data losses or breaches. For example, blockchains may store encrypted information and coded pointers to distributed storage locations that may be spread across distributed computer networks. Such a method may prevent those seeking to access or alter the information in an unauthorized manner from doing so by creating a highly distributed temporal infrastructure which may be impractical to reconstruct or, for example, impossible to reconstruct even if the unauthorized user is able to obtain a portion of the information associated with the blockchain.

In an embodiment of the present invention, blockchain and AI processing may be used to provide, for example, robust validation techniques to prevent such things as Sybil attacks, for example, and dismiss masquerading hostile entities by providing a secure identity and/or authorization mechanism. For example, a local entity may accept a remote encrypted identity blockchain based on a central authority which may ensure a one-to-one correspondence between an identity and an entity and may even provide a reverse lookup. The identity may be validated either directly or indirectly. In direct validation the local entity queries the central authority to validate the remote identities. In indirect validation the local entity relies on already accepted identities which in turn vouch for the validity of the remote identity in question.

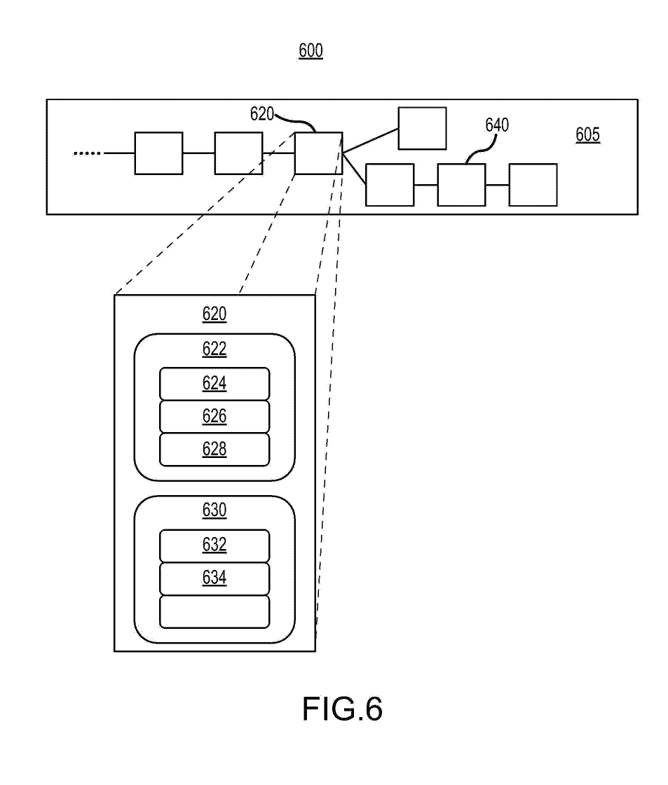

In an embodiment of the present invention, a distributed secure transaction ledger, in the form of a block chain, may be used to communicate data between parties. As illustrated in FIG. 6, a block chain or decentralized secure transaction ledger 605 may be one that is maintained by nodes in a distributed network. Although each block of ledger 605 may contain differentiated information and may have distinct purposes, as illustrated in FIG. 6, block 610 contains a sample communication or message according to embodiments of the present invention.

In an embodiment of the present invention, ledger 605 may be used to send messages between at least two users of a system through, for example, nodes in a network. By way of non-limiting example only, a message in block 620 of the ledger 605 may contain a header 622 and contents 630. The header 622 may comprises at least one block ID 624 for block 620, a block ID 626 of the previous block, and a nonce value 628, an arbitrary number that may be used as a cryptographic hash function. These values and block information may be used in linking blocks together to form a chain.

The contents 630 may comprise one or more messages 632 and may also include other data 634. In an embodiment on the present invention, a message 632 may comprise a unique identifier of the owner/originator/sender of the message. This information may be used for one or more purposes, such as, for example, to identify the owner or sender to provide a way by which a third-party node or nodes that handle and or process the ledger 605. Additionally, the identifier of the owner/sender may be used or linked to an authentication module and/or server associated with using the block chain as a communication channel, or for other actions. Indeed, block 620 may include any number of identifiers which may for example, be used to indicate whether or not the ledger 605 should be directed to a different identifier than the originator of the message 632. As would be appreciated by those skilled in the art, message 632 may include data for processing, which may be obfuscated using, for example, homomorphy transformation.

In an embodiment of the present invention, ledger 640 may be used to send encrypted and secure messages between users through public systems, private/closed systems, or a combination thereof. Similar to the message(s) in block 620, the contents of ledger 640 may comprises one or more messages and may also comprise other encryption/authentication data. In an embodiment of the present invention, a message contained in ledger 640 may comprise a unique identifier of the recipient of the message, which may be the originator of the initial message or another entity. The message may include a unique identifier of the node that submitted the message. Such may be used for one or more purposes. For example, the identifier may help identify who sent the message. Additionally, the identifier may be used or linked to an authentication server/module associated with using the block chain as a communication channel, for performing security, authentication, resolving, or other actions.

In an embodiment of the present invention, the message 632 may include a digitally signed message checksum as way to verify the message. For example, the sender of the message may digitally sign a checksum or hash of the message using his or her private key. A receiving device can verify the integrity of the data by verifying the checksum or hash using the sender's public key. Those having skill in the art shall recognize that other methods for verifying the data's integrity may also be employed herein.

A supply chain is generally used in a system for moving commodities from a supplier, such as a factory, to a warehouse, and finally to a consumer. The supply chain in this context is generally used to track all activities, such as processing of materials at a factory, the formation of a product, and the subsequent delivery to the consumer.

The disclosed embodiments provide a supply chain as applied to people to create a skill's passport for an individual user. Essentially a supply chain for people. The skill's passport may take on a T-Shaped data structure for an individual, their identity, and their unique brand. In one embodiment, the T-Shaped data structure may be maintained on a blockchain. A link or code to the data structure may be provided in hard copy form, such as on a business card. The link or code may be in scan able format, such as a QR code, or the like. Information provide may include, but is certainly not limited to, the person's biography, skills, past job/work/life experience, and education credentials/history. Further, the T-Shaped data structure may provide a data visualization of a person's passport providing at least three components:

1) passport—T-Shaped data visualization of user's passport (skills, assessments, experience, education, grades, certifications, etc.)

2) resumes—capture applied knowledge—how skills are used—measure applied knowledge, what skills were used to accomplish work/education

3) supply chain—roles—how does flow of supply/demand work? supply->resume

### Implementation Examples

Based on the above data structure, a series of implementations may be entirely possible. Including, but not limited to, the below example use cases.

The T-Shaped data structure may be utilized in the classroom. Based on identified skills needed in the workplace, mentors may be matched to current students in the classroom. Mentors may provide focused curriculum with respect to real-world skills needed in the workplace. Students may then be provided with a keen understanding of the workplace and therefore optimize the skills needed to work efficiently. This provides an optimized workforce. Students may therefore be connected their passion, having their passion cultivated and connected to a job/career they'll enjoy and actually want to do. In further embodiments, the data structure may showcase certain individuals over time.

Taxonomy—4-Tier taxonomy in combination with supply/demand model—SAAS Skills Language

The tech platform enables employers to extend real world project and examples of what they're doing now to students to work on while in school and with rigor of real project team (rules, taxonomy, skills and competencies needed (hard and soft skills). Productivity as to how students are applying their knowledge is determined as well as ways to assess an individual's ability.

A digital multimedia resume may be created using the T-Shaped data structure. A user's skills passport may include uploaded documents (i.e. credentials), a skills section (validated data), a star rating (for example, 1-5), validation of the user's involvement in different jobs/positions/experiences, and certificates (start/end data, certification number, etc.).

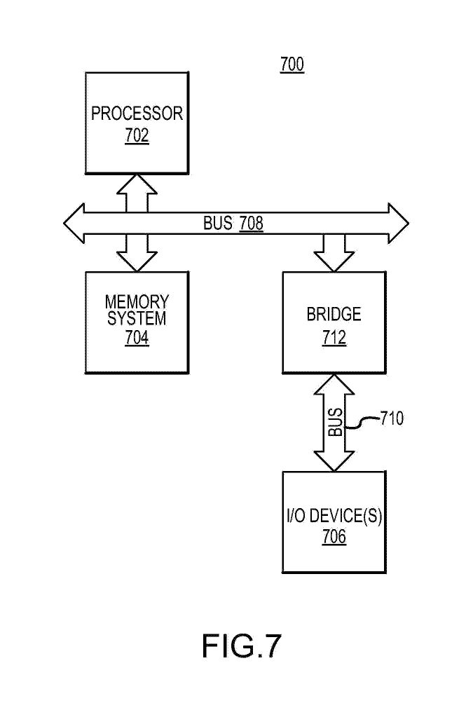

FIG. 7 is an example of a simplified functional block diagram of a computer system 700. The functional descriptions of the present invention can be implemented in hardware, software or some combination thereof. For example, a computing platform and an NLP engine of the present invention can be implemented using a computer system.

As shown in FIG. 7, the computer system 700 includes a processor 702, a memory system 704 and one or more input/output (I/O) devices 706 in communication by a communication ‘fabric’. The communication fabric can be implemented in a variety of ways and may include one or more computer buses 708, 710 and/or bridge and/or router devices 712 as shown in FIG. 7. The I/O devices 706 can include network adapters and/or mass storage devices from which the computer system 700 can send and receive data for generating and transmitting advertisements with endorsements and associated news. The computer system 700 may be in communication with the Internet via the I/O devices 708.

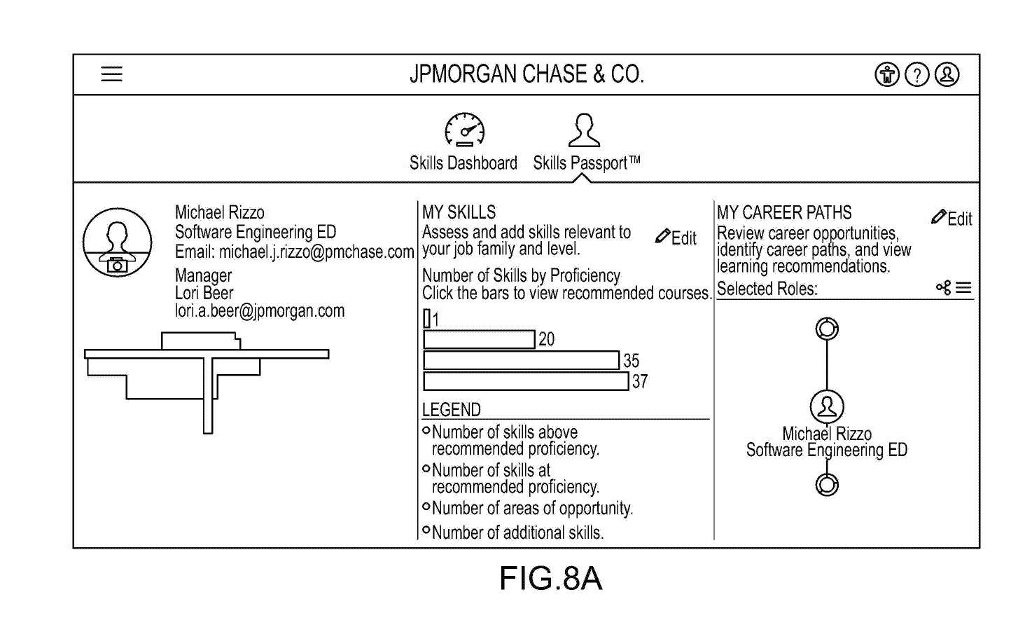

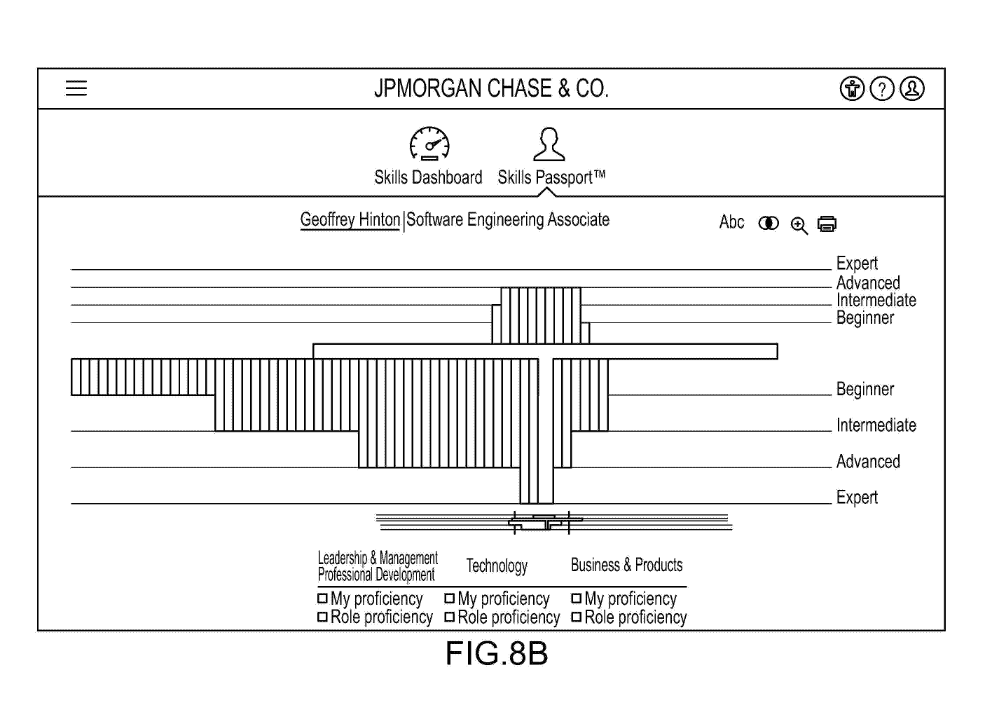

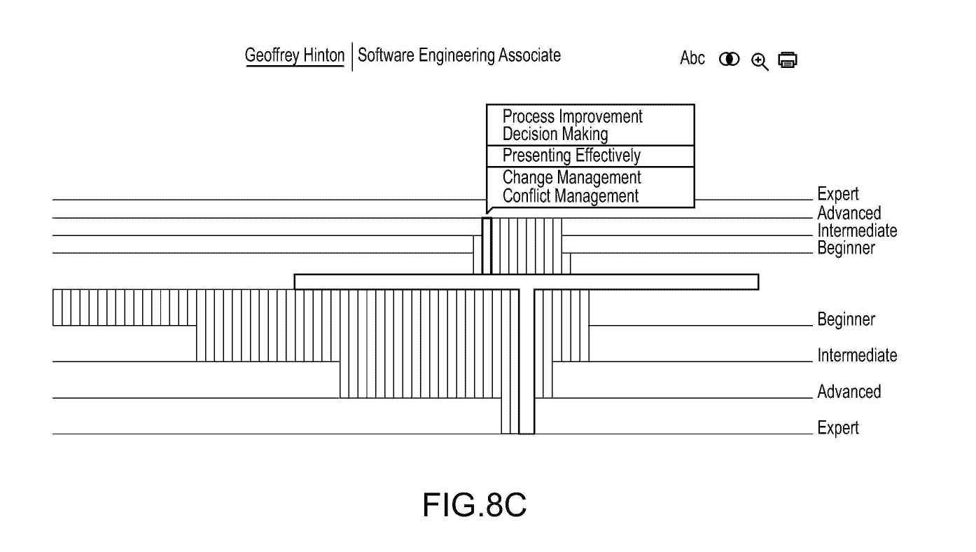

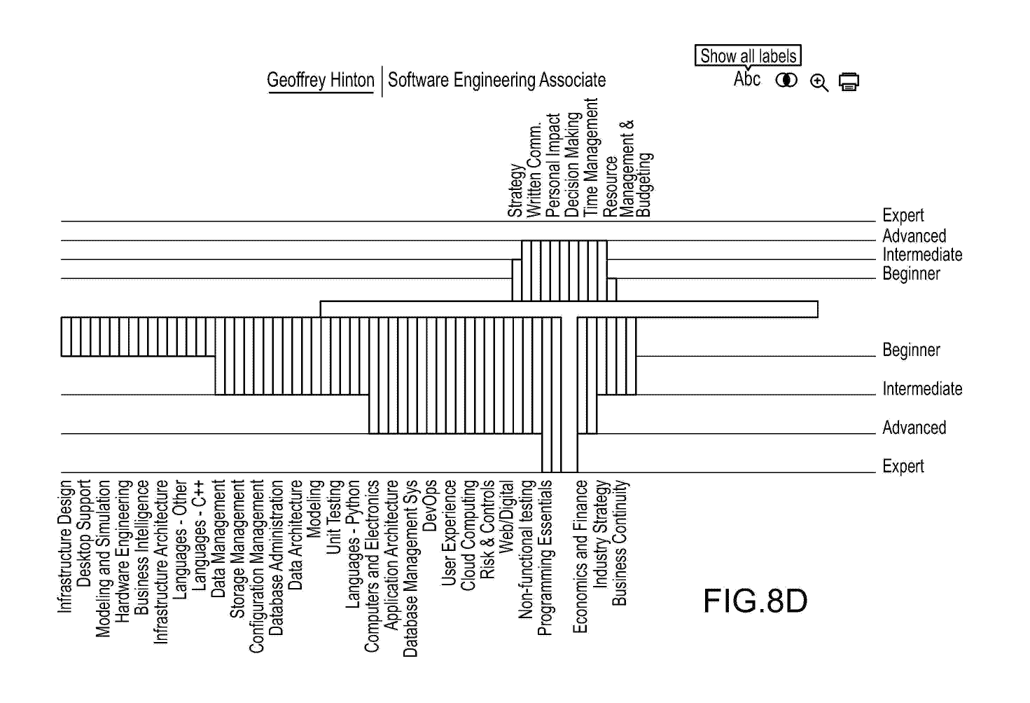

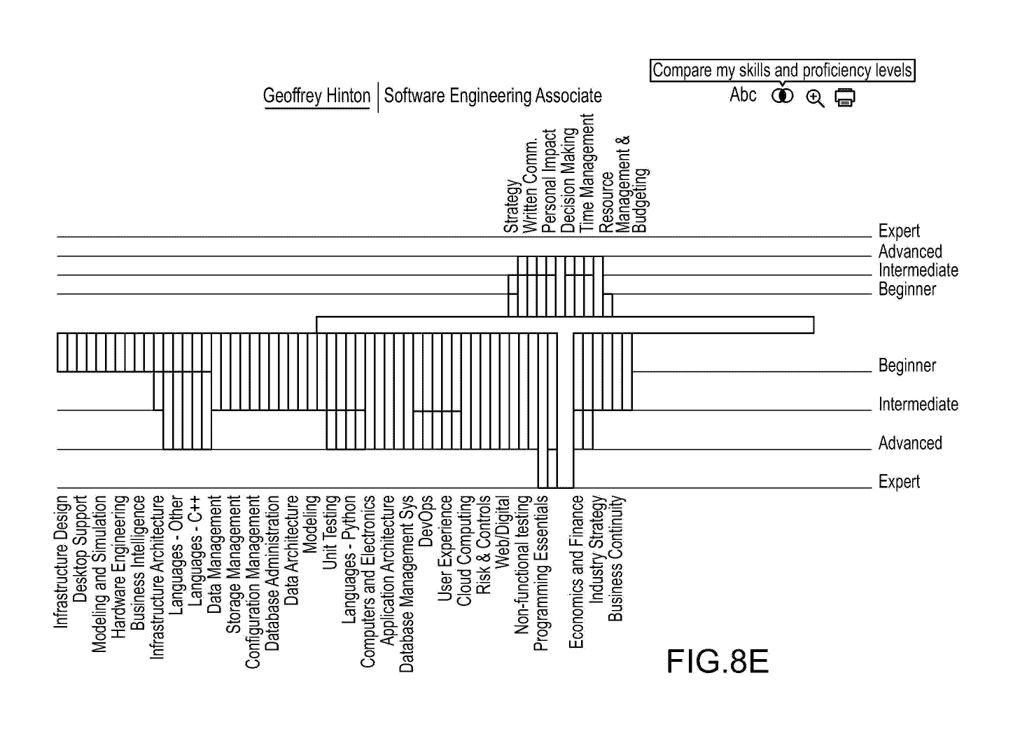

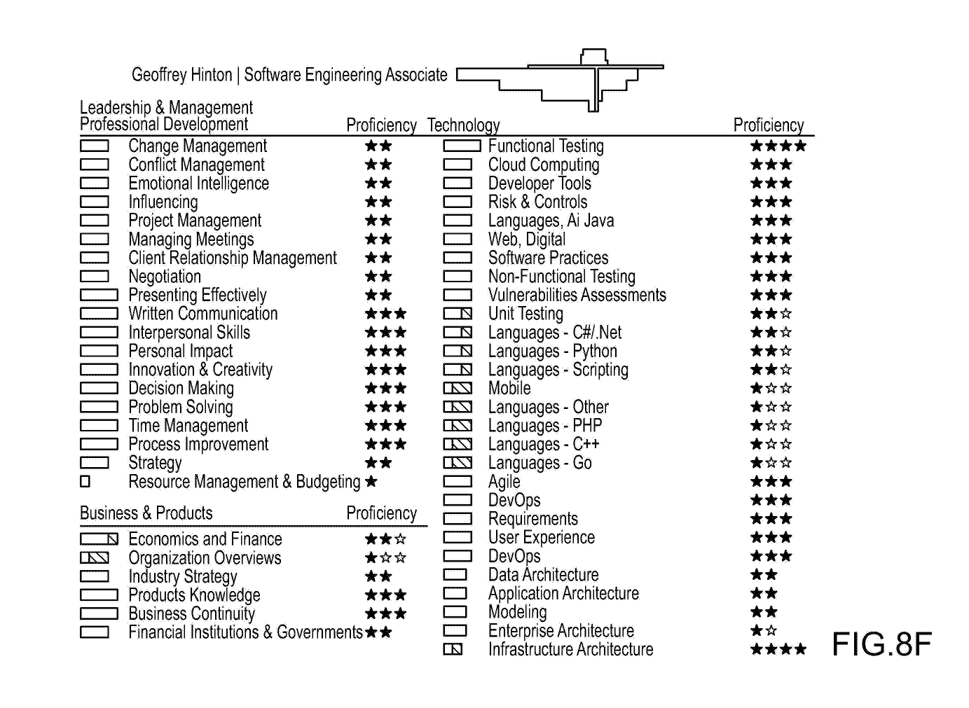

FIGS. 8A-8F provide exemplary screenshots and data visualizations of the above embodiments. FIG. 8A illustrates an exemplary mini T-Shape visualization appearing on a user's skills passport dashboard. The dashboard may include the user's full name and title, manager information, a T-shaped visual, a listing of skills possessed by the user, career path (user-editable), and currently selected roles. Selection of the mini T-Shape visualization brings the user to a default view of the T-Shape, as illustrated by exemplary FIG. 8B. The mini T-Shape is an accurate representation of the user's skills and proficiencies. For the mini version, the color blocks may be solid and the skills may be shown undivided.

As shown in FIG. 8B, the default view of the T-Shape may comprise of a static T-Shape graphic surrounded by a user's role and additional skills, divided into at least three categories.

1. Leadership & Management+Professional Development: Positioned above the T-Shape
2. Technology: Positioned to the left of the T-Shape
3. Business & Products: Positioned to the right of the T-Shape

Within each category, skills may be ordered so that those with highest proficiency will appear closest to the center of the T-Shape. Two different scale may be displayed above and below the T-Shape's horizontal bar. Each scale may have the following values: Beginner, Intermediate, Advanced, and Expert. A header may be displayed showing the user's name and role and may include buttons to perform certain actions. These actions may include:
Show All Labels
Compare My Skills and Proficiency
Zoom
Print

Hovering over the buttons may trigger tool tips informing the user of associated functionality. The footer may include a zoom slider and a legend describing features of the data visualization graph. The zoom slider may allow the user to focus in on particular segments of the graph. The T-Shape graph may zoom accordingly within its viewport window.

As shown in FIG. 8C, the data visualization window may provide skill popup functionality. By hovering over a certain skill bar, such as with a mouse or some other pointing device, a popup window may appear above or below the skill bar. The popup may contain a list of skills. The skill which is currently under hover may become highlighted and will appear in the middle of the list. The neighboring skills may be listed above and below.

As shown in FIG. 8D, the data visualization window may enable a Show All Labels functionality. By clicking on a button, the window may toggle on/off descriptive labels on each of the skills represented on the graph.

As shown in FIG. 8E, the data visualization window may enable a Compare My Skills and Proficiency functionality. Utilizing this button will toggle on/off the recommended proficiencies associated with each skill within the user's role. Recommended proficiencies may be represented by candy-cane (or striped) style bars while the user's actual proficiencies may be represented by solid bars. A zoom functionality may be provided by the data visualization tool. Engaging a zoom feature, such as by clicking on a zoom button, may increase the size of the T-Shape to allow the user to view and interact with a segment of the chart at a higher resolution. Clicking the zoom button again will return the chart to standard size. While in zoom mode, the user can pan around the chart vertically and horizontally. The segment of the chart currently in the viewpoint will be reflected in the zoom slider.

As shown in FIG. 8F, the data visualization tool may provide a print functionality. Clicking on the Print icon triggers a modal containing a print friendly table view of the data represented on the T-Shape. The view may be suitable for printing a hard copy or saving as a PDF in portrait orientation.

The T-Shape feature may be developed to meet with Web Content Accessibility Guidelines (WCAG) Level AA. The T-Shape may be accessible to colorblind users and an alternative description of the data represented by the graph may be provided for use by screenreader software.

Those of ordinary skill in the art will recognize that many modifications and variations of the present invention may be implemented without departing from the spirit or scope of the invention. Thus, it is intended that the present invention cover the modification and variations of this invention provided they come within the scope of the appended claims and their equivalents.

The various illustrative logics, logical blocks, modules, and engines, described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of instructions on a machine readable medium and/or computer readable medium.

Those of skill in the art will appreciate that the herein described apparatuses, engines, devices, systems and methods are susceptible to various modifications and alternative constructions. There is no intention to limit the scope of the invention to the specific constructions described herein. Rather, the herein described systems and methods are intended to cover all modifications, alternative constructions, and equivalents falling within the scope and spirit of the disclosure, any appended claims and any equivalents thereto.

In the foregoing detailed description, it may be that various features are grouped together in individual embodiments for the purpose of brevity in the disclosure. This method of disclosure is not to be interpreted as reflecting an intention that any subsequently claimed embodiments require more features than are expressly recited.

Further, the descriptions of the disclosure are provided to enable any person skilled in the art to make or use the disclosed embodiments. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but rather is to be accorded the widest scope consistent with the principles and novel features disclosed herein.

I claim:

1. A data structure stored on at least one computing device, comprising:
a first data field comprising a first set of skills comprising leadership, management, and professional development skills;
a second data field comprising a second set of skills comprising technology skills; and
a third data field comprising a third set of skills comprising business and products skills.

2. The data structure of claim 1, wherein the first, second, and third data fields are placed on a proficiency scale of 1-5.

3. The data structure of claim 1, wherein the data structure is accessible via a link.

4. The data structure of claim 1, wherein the data structure is accessible via a code.

5. The data structure of claim 1, wherein the data structure is stored and maintained on a blockchain.

6. The data structure of claim 1, wherein the contents of the data structure may be displayed via a data visualization graph incorporating data gleaned from the first, second, and third data fields.

7. The data structure of claim 6, wherein the data visualization graph is a T-Shaped graphical representation.

8. The data structure of claim 7, wherein the first set of skills are visualized above the T-Shape.

9. The data structure of claim 7, wherein the second set of skills are visualized to the left of the T-Shape.

10. The data structure of claim 7, wherein the third set of skills are visualized to the right of the T-Shape.

11. An interactive data visualization graph stored on a computing device and rendered on a display, comprising:
a T-Shape graph surrounded by a user's role and additional skills, the user's role and additional skills comprising:
a first set of skills comprising leadership, management, and professional development skills;
a second set of skills comprising technology skills; and
a third set of skills comprising business and products skills;
two scales, one displayed above and one displayed below a horizontal bar of the T-Shape graph.
a header displaying one or more interactive buttons; and
a footer displaying one or more interactive buttons.

12. The interactive data visualization graph of claim 11, wherein the first set of skills are visualized above the horizontal bar of the T-Shape graph.

13. The interactive data visualization graph of claim 11, wherein the second set of skills are visualized to the left of and below the horizontal bar of the T-Shape graph.

14. The interactive data visualization graph of claim 11, wherein the third set of skills are visualized to the right of and below the horizontal bar of the T-Shape graph.

15. The interactive data visualization graph of claim 11, wherein the one or more interactive buttons of the header includes: show all labels, compare my skills and proficiency, print, and zoom.

16. The interactive data visualization graph of claim 11, wherein the one or more interactive buttons of the footer includes: a zoom slider and a legend.

17. The interactive data visualization graph of claim 11, wherein each of the two scales comprises beginner, intermediate, advanced, and expert.

18. The interactive data visualization graph of claim 11, further comprising:
a popup feature in response to a user action, the popup feature providing a list of skills highlighting a skill currently hovered over by the user action.

19. The interactive data visualization graph of claim 11, wherein the T-Shape graph is accessible via a link or a code printed on a card.

20. The interactive data visualization graph of claim 11, wherein the T-Shape graph is stored and maintained on a blockchain.
